(19) United States
(12) Patent Application Publication
(10) Pub. No.: US 2013/0027203 A1
(43) Pub. Date: Jan. 31, 2013

(54) Delayed Entry Alert & Detection Switch

(71) Applicant: Chester James, Orinda, CA (US)

(72) Inventor: Chester James, Orinda, CA (US)

(21) Appl. No.: 13/549,462

(22) Filed: Jul. 14, 2012

Related U.S. Application Data
(60) Provisional application No. 61/572,758, filed on Jul. 21, 2011.

(51) Int. Cl. G08B 13/00

(52) U.S. Cl. 340/541

(57) ABSTRACT

An intrusion detection device including microcontroller, a light emitting diode (2); a passive infrared motion detector module (3), and a keypad (5). All components comprising the device are contained in a box with a maximum volume of 12 cubic inches.

### CROSS-REFERENCE TO RELATED APPLICATIONS

This application is entitled to the benefit of Provisional Patent Application No. 61/572,758 filed Jul. 21, 2011.

### BACKGROUND

### Field of Invention

This invention relates to a personal intrusion detection device.

An intrusion detection device for protection of individual property and private spaces which themselves may reside inside of an area protected by a general alarm system.

### BACKGROUND

### Description of Prior Art

General alarm systems have previously been designed to alarm or alert when an area has been entered or invaded. However, this does not address the problem of invasion into personal property or private spaces within the aforementioned area. This is especially true when intrusions are perpetrated under a breath of trust by someone who is permitted to be in the area for legitimate reasons, after the general alarm system has been deactivated.

### SUMMARY

An intrusion detection device contained in a small box of no more than 12 cubic inches, and includes:
(a) a keypad to input data
(b) a motion detection module to detect intrusions
(c) a microcontroller to process data
(d) a light-emitting diode to display information
(e) an audio outlet to accommodate a buzzer.

### Objects and Advantages

Accordingly, several objects and advantages of my invention are:
(a) The intrusion detection device can be used as an alternative or supplement to more elaborate general alarm systems.
(b) The intrusion detection device can be concealed internally and an intruder is likely to be unaware that an enclosed space is being monitored.
(c) The intrusion detection device is self-contained, designed to be portable and transportable for use wherever it is needed.

### DRAWING FIGURES

FIG. 1 is a 3D perspective of the front, top and right side of the intrusion detection device.

FIG. 2 is a 3D perspective of the front, bottom and left side of the intrusion detection device.

FIG. 3 is a 3D perspective of the back, top and left side of the intrusion detection device.

### REFERENCE NUMERALS IN DRAWINGS

1 On/Off button

2 Light-emitting diode

3 Motion detector module

4 AC/DC power adapter inlet

5 Keypad

6 Audio outlet

7 Battery compartment

### DESCRIPTION

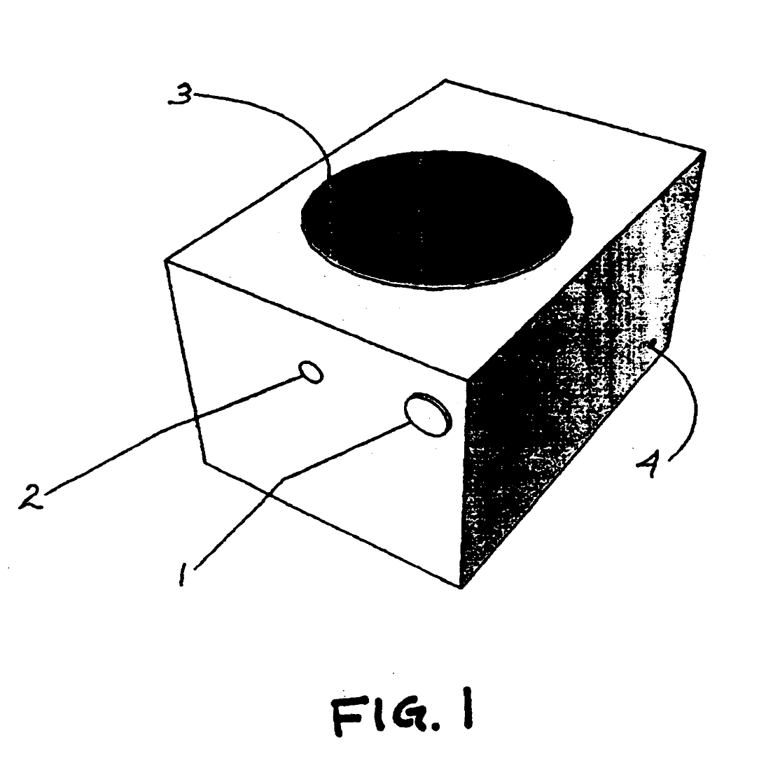

FIGS. 1, 2 and 3—Preferred Embodiment

FIG. 1 shows a 3D perspective of the intrusion detection device with the front, top and right hand side exposed. The front panel contains an on/off button and a light-emitting diode. The top panel contains a motion detector module. The right hand panel contains an inlet for an AC/DC power adapter.

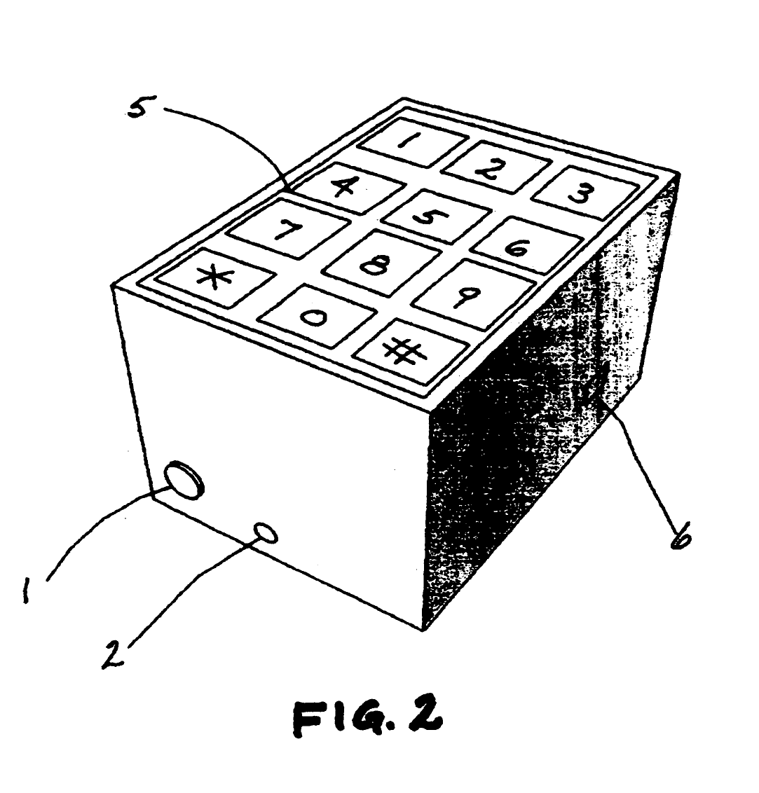

FIG. 2 shows a 3D perspective of the intrusion detection device rotated to expose the bottom and left hand sides, along with the front panel upside-down. The bottom' panel contains a 12 button keypad. The left hand panel contains an outlet for audio. The front panel continues to be exposed with the on/off button and light-emitting diode in an upside-down position.

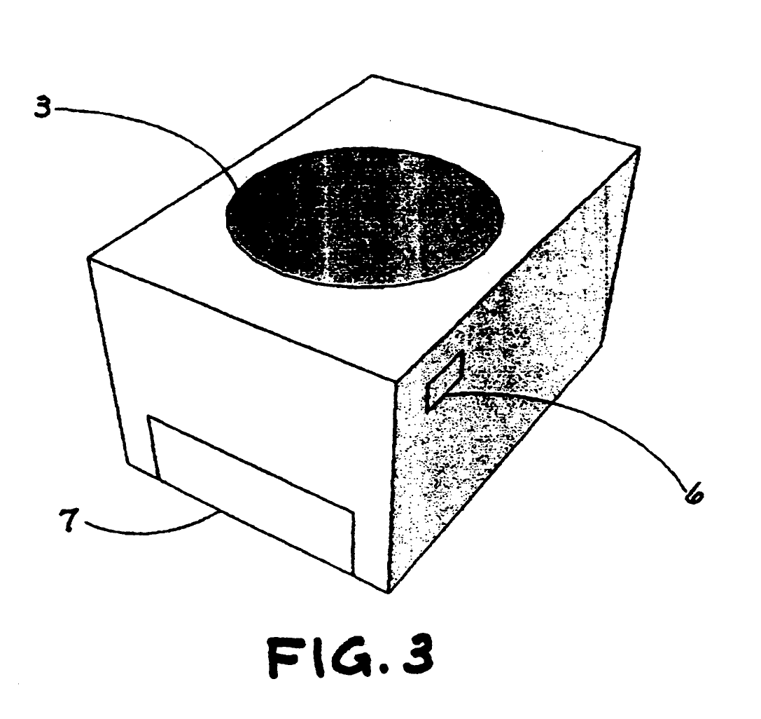

FIG. 3 shows a 3D perspective of the intrusion detection device rotated to expose the back side, along with the top side and left hand side. The back side contains a battery compartment. The left hand panel contains an outlet for audio. The top panel contains a motion detector module.

The intrusion detection device is small, contained in a box of 12 cubic inches maximum.

### OPERATION

FIGS. 1, 2 and 3

The manner of using the intrusion detection device involves concealing the device inside the space or enclosure to be monitored against intrusions.

Namely, the size of the device shown in FIG. 1-FIG. 3 allows it to be placed in spaces or inside enclosures which need protection or surveillance; and to travel inside mobile objects.

An on/off button 1 (FIG. 1) is used to activate and de-activate the device.

A motion detection module 3 (FIG. 1) is used to sense the presence of an intruder The motion detector provides input data to a microcontroller. The microcontroller processes the input data.

A light-emitting diode 2 (FIG. 1) responds to signals from the microcontroller.

An audio outlet 6 (FIG. 2) responding to signals from the microcontroller.

A keypad 5 (FIG. 2) allows user data input to the microcontroller.

An AC/DC power adapter 4 (FIG. 1) can be used as an alternative to battery power 7 (FIG. 3).

1. A portable intrusion detection device comprising:
a) a microprocessor;
b) a motion detector module;
c) a keypad; and
d) a light emitting diode.

2. The microprocessor, motion detector module, keypad and light emitting diode of claim 1 are all contained in a box with a maximum volume of 12 cubic inches.
